(19) United States
(12) Patent Application Publication
(10) Pub. No.: US 2005/0017038 A1
(43) Pub. Date: Jan. 27, 2005

(54) Apparatus and vehicle accessory kit for use with a truck bed tool box

(76) Inventor: Kenneth R. Johnson, Torrington, CT (US)

Correspondence Address: DAMIAN G.WASSERBAUER;INTELLECTUAL PROPERTY ADVISORS LLC, PO BOX 156, CANTON, CT, 06019, US

(21) Appl. No.: 10/615,425

(22) Filed: Jul. 7, 2003

(51) Int. Cl. B60R 7/00; B60R 9/00; B60R 11/00

(52) U.S. Cl. 224/404; 224/558

(57) ABSTRACT

An apparatus and kit is provided for securing a toolbox to a truck bed using a spacer member. The spacer member is configured to elevate the toolbox above the truck bed at a predetermined elevation so as to allow for the storage of oversized materials. The spacer member is securely locked to each of the truck and toolbox to maintain the desired elevation.

### BACKGROUND OF INVENTION

1. Field of the Invention

The present invention relates generally to truck accessories and in particular to an apparatus useful to elevate a toolbox above a truck bed.

2. Description of the Related Art

Many persons in the trades and construction own trucks that utilize an add-on utility or toolbox adapted to be located within the truck bed and mounted to the parallel rails of the truck bed. Truck toolboxes are configured to be located in the cargo bed of a vehicle and are utilized to store tools and other equipment such as, for example, U.S. patent and application Publication Nos. 5,967,392; 5,685,467, 5,169,200, 4,967,944, 4,936,634, 4,892,346, 4,534,798, and 2001/0032848 A1. Such toolboxes utilize the side rails, feet structures or the like so as to extend the base of the toolbox to the bed portion of the cargo bed. Truck tool boxes can have a construction of steel, plastic or other composite materials and many have organizational features, e.g. U.S. Pat. No. 5,634,577 and U.S. patent application Publication No. 2001/0032848 A1. Some toolboxes are collapsible and configured to create partitions for security storage. U.S. Pat. No. 4,828,312. Various security and mounting arrangements have been invented for mounting the toolbox such as, for example, U.S. Pat. Nos. 4,998,425 and 4,249,295 for Tool Box Securing Arrangement and Method of Mounting a Tool Box on a Truck, respectively. Additional partitioning and hinge devices have been developed to create a larger volume storage compartment than previously known by straddle-bed toolbox assemblies such as disclosed in U.S. Pat. No. 4,580,827.

Tool boxes have been located on each side wall of the truck such as, for example, U.S. Pat. No. 6,467,663 B1, which discloses hinged side bay containers located on each of the side rails of the truck bed. Similarly, application Publication No. 2002/0153738 A1 discloses a multi-functional cargo bed assembly having storage containers located therein and adjacent the side rails of the truck bed. The side rails also have been configured to create volume partitions within the truck bed. U.S. Pat. No. 4,944,544.

Alternatively, Add-on toolbox transports can allow the toolbox to be movable within the truck bed to the extent of a rail system such as, for example, U.S. Pat. No. 6,624,083 B1. Various brackets have been developed for a utility rack and elongated mounting system such as, for example, U.S. Pat. No. 4,773,575. Finally, truck bed supports have been developed to support four-by-eight sheets of plywood in a pick-up truck bed as illustrated in U.S. Pat. No. 6,170,896 B1.

There are several disadvantages to conventional truck toolboxes because the configuration causes problems or prohibits transporting oversized material such as, for example, elongated lumber, pipe, sheets of plywood & sheet rock or other building stock. The choice has been sometimes whether the toolbox and materials occupy the truck bed at the same time without removing the toolbox from the side rails. Alternative arrangements have, as in U.S. Pat. No. 4,103,956 a pick-up truck toolbox that caps the truck bed. However, the capped design has the disadvantage of further limiting the capacity of the truck bed as well as the size and type of material that is utilizable in toolbox designs that do not entirely cap the truck bed. Finally, it is desire ultimately desirable in the transportation of such materials that the truck bed gate be closed in transport.

As the available related art did not disclose any patents that suggest, teach or discuss, or anticipate directly. Consequently, a need is present and felt for an apparatus that overcomes the above-identified problems. What is needed is an apparatus to increase cargo area of the truck bed having a tool box disposed therein, thereby allowing oversized materials to be conveniently stored and accommodated by the existing cargo area. In particular, an apparatus to elevate a tool box above a truck bed having first and second side walls, and connectors mounting the first and second brackets to the first and second side walls, respectively, for elevating a cargo box above the associated side rail. It is advantageous to elevate the toolbox thereby adapting the bed to receive, for example, four-by-eight-foot sheets of plywood or drywall to lie flat on the truck bed.

### SUMMARY OF INVENTION

A toolbox apparatus is provided which can be used with a truck bed. The apparatus includes a bracket and securing assembly. The bracket is a generally F-shaped configuration, which elevates the toolbox above the truck bed a predetermined height so as to allow oversized materials to be stored thereunder. The securing assembly secures the bracket to each of the truck bed and the toolbox at the predetermined height. The apparatus can be assembled into a bracket kit with the bracket having a series of holes configured to match up with holes in the truck bed and the toolbox. Furthermore, the bracket can be made of a unitary construction and can further be configured to be releasably secured to the toolbox or side wall, or both, to facilitate removal.

Other objects and improvements of the invention will be explained in more detail below.

### BRIEF DESCRIPTION OF DRAWINGS

For a full understanding of the preferred embodiment of the present invention, reference may be made to the following detailed description taken in conjunction with the accompanying drawings in which:

FIG. 1 is a perspective breakaway view of the truck bed toolbox bracket of the present invention;

FIG. 2 is a perspective breakaway view of the toolbox and bracket of the present invention;

FIG. 3 is a perspective view of the securing assembly and bracket of the present invention;

FIG. 4 is a perspective view of the securing assembly of the present invention;

FIG. 5 is a perspective view of the bracket of the present invention; and

FIG. 6 is a perspective view of the unitary bracket assembly of the present invention.

### DETAILED DESCRIPIION

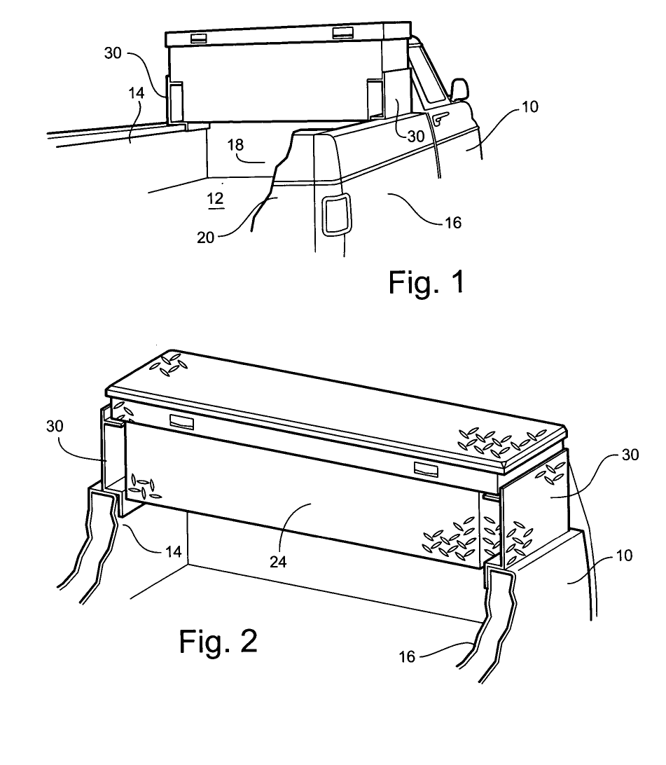

Referring now more specifically to the drawings, in FIG. 1 a pickup truck 10 includes a load or cargo area 12 having upwardly formed side walls 14, 16 and 18, a rear hatch assembly or tailgate 20 located between the side walls 14 and 16, and a bed 22 formed flat or generally planar with raised longitudinal ribs. The rear hatch assembly 20 and can be hinged to provide access to the cargo area 12 between open and closed positions. The side walls 14, 16 and 18 and the rear hatch assembly 20 form the cargo area 12 of the truck 10. A tool box 24 of a conventional construction can be secured in the cargo area 12 of the truck 10 utilizing attachments devices 26 such as bolts, clamps, posts, handle and the like. Each side wall 14 and 16 of the truck 10 typically includes a formed recessed flange 28 that is useful to secure the attachment devices 26 the tool box 24 to the side walls 14 and 16 as is illustrated in FIGS. 4 and 5.

As is illustrated in FIGS. 1, 2 and 5, according to a preferred embodiment of the present invention a bracket 30 includes an elongated body 32 having a shelf 34 and base 36. The body 32 is configured to be of similar width of the tool box 24. The body 32 includes a facing surface 32a and a back surface 32b. The body portion 32 can be made from aluminum stock with a bright tread plate finish for a facing surface 32a. An aluminum tread plate finish provides a durable finish useful in harsh environments. It may be important to certain truck owners to match the design of the toolbox. AS a result, the tread plate finish of the present invention will match the finish that is used in the exterior design of certain tool boxes 24, such as, for example, truck toolboxes manufactured and available under the trade name DELTA by Delta Consolidated Industries. The shelf 34 and base 36 can be formed integral or otherwise attached by welds to the rear surface 32b. The shelf 34 and base 36 include holes 38 formed therein to align with corresponding holes 40 formed in the tool box 24 and side walls 14 and 16, respectively. The shelf 34 is used to support and hold an edge portion of the tool 24 thereto using attachment devices 26.

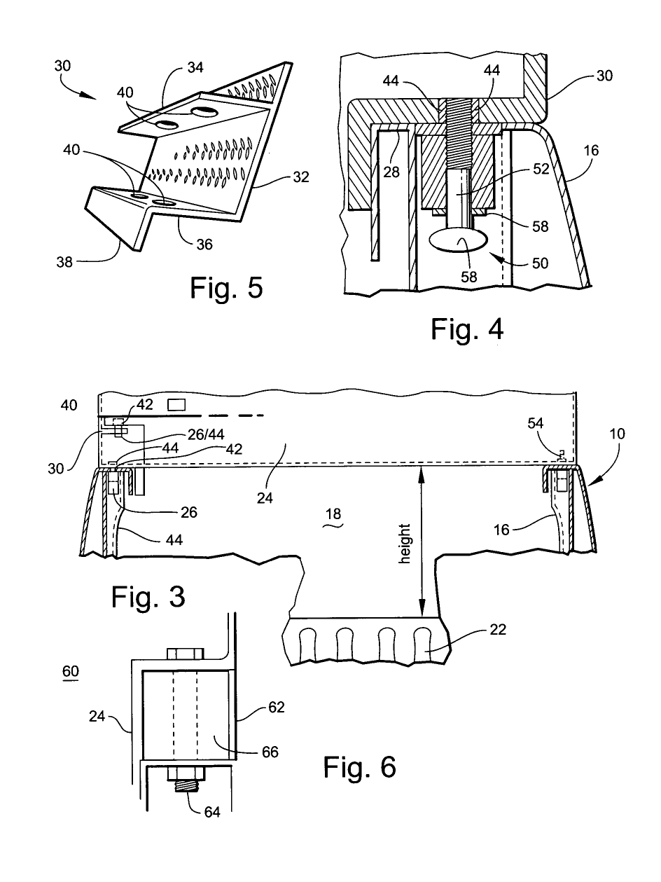

Referring now to FIGS. 3 and 4, the present invention includes a releasable attachment device 50 is formed integral to the bracket 30. The attachment device includes a threaded shaft 52 and a handle 54. The handle 54 has an integral locking collar 56 that

In an alternative embodiment the bracket 30 may include threaded portions 44 formed integral to the shelf 34 and base 36 as shown in FIG. 4. The integral threaded portions 44 which aligned with the series of holes 40 in the side walls 14 and 16 and the series of holes 40 in the tool box 24. The integral threaded portions 44 can then be used to accept the appropriate attachment device 26 or 50, with quick release handle, so as to secure the tool box 24 and bracket 30 to the side walls 14 and 16 of the truck 10, or combinations thereof.

Referring to FIG. 4 the securing means includes a bolt 52, nut 54, lock washer 56 or handle 58

Referring to FIG. 6, in an alternative embodiment of the bracket 60 having a face portion 62, a fastener 64 and a spacer shelf 66. The spacer shelf 66 is of a unitary construction using a rubber compound and affixed to the face portion.

In an alternative embodiment of the present invention, the bracket 60 includes a base member operating as a facing portion 62 formed in a L-Flange shape and affixed to unitary shelf spacer 66. The unitary construction can improve the shock absorption ad reduce noise in this alternative construction of the bracket 60.

Therefore, the foregoing is considered illustrative of the principles of the invention and is a description of the disclosed embodiments to enable any person skilled in the art to make or use the present invention. Various modifications to these embodiments will be readily apparent to those skilled in the art, and the generic principles defined herein can be applied to other embodiments without departing from the spirit or scope of the invention. For example, the present invention can be practiced with [KJ: other method or apparatus that we think of after review of this draft]. It is therefore desired that the present embodiments be considered in all respects as illustrative and not restrictive, reference being made to the appended claims rather than the foregoing description to indicate the scope of the invention

1) A tool box bracket kit for use with a truck bed comprising:
A bracket, said bracket being generally a generally F-shaped configuration, said bracket being configured to elevate the tool box above the truck bed a predetermined height so as to allow oversized materials to be stored thereunder; and
Means to secure said bracket to each of the truck bed and the tool box at said predetermined height

2) The toolbox bracket kit as described in claim 1, wherein said bracket further comprises a series of holes configured to match up with holes in the truck bed and the toolbox.

3) The toolbox bracket kit as described in claim 2, wherein said predetermined height is correlated to the desired space clearance between the bed and the lower portion of the toolbox for allowing oversized material.

4) The tool box bracket kit as described in claim 3, said bracket designed to be releasably secured to the tool box

5) The tool box bracket kit as described in claim 4, said bracket designed to be releasably secured to a rail of the truck bed.

6) The tool box bracket kit as described in claim 5, wherein said securing means is located on said bracket, said securing means being a nut, lock washer and bolt assembly.

7) The toolbox bracket kit as described in claim 6, wherein said securing means is a clamp for secured to a rail of the truck bed and to the toolbox.

8) The tool box bracket kit as described in claim 7, a series of holes located on each bracket at a location where said bracket is configured to rest against the tool box

9) The toolbox bracket kit as described in claim 8, wherein a series of holes is located on each bracket at a location where said bracket is configured to rest against the rail of the truck bed.

10) The toolbox bracket kit as described in claim 9, at least one bolt used to secure said holes in said bracket to the truck rail and the toolbox.

11) A tool box suspension system for use with a truck bed having two side walls and a floor, comprising essentially of:
bracket means for suspending the tool box from the side walls of the truck bed, said bracket means including a securing means to secure said suspending means to each side wall and to the tool box at a desired elevation above the floor of the truck bed.

12) The system described in claim 11, wherein said securing means is a series of threaded hole portions formed in said bracket means which aligned with series of hole portions in the side walls and tool box so as to accept a fastener means threaded there through.

13) The system described in claim 12, wherein the desired elevation is a sufficient height above the floor to allow for allowing oversized material is four by eight sheets, pipe, or other materials to thereby increase the volume of the truck bed to accommodate such oversized material.

14) An apparatus for securing a tool box to a truck bed consisting substantially of:
a spacer member, said spacer member being configured to elevate a tool box above a truck bed to allow for the storage of oversized materials; and
means to lock together said spacer member and the truck and toolbox.

15) The apparatus as described in claim 14, wherein said spacer member is comprised of steel and forms a generally combined T- and F-shaped member.

16) The apparatus as described in claim 14, wherein said spacer member is comprised of a soft material such as rubber or other suitable plastics.

17) The apparatus as described in claim 14, wherein said spacer member is configured to be secured by at least a bolt and a nut.
